(19) United States
(12) Patent Application Publication
(10) Pub. No.: US 2003/0128391 A1
(43) Pub. Date: Jul. 10, 2003

(54) Point notification method, point notification system, and computer-readable recording medium in which point notification program is recorded

(75) Inventor: Miyuki Sato, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/144,989

(22) Filed: May 15, 2002

(30) Foreign Application Priority Data
Jan. 8, 2002 (JP) 2002-001687

(51) Int. Cl. G06K 1/00; G06F 15/00

(52) U.S. Cl. 358/1.18

(57) ABSTRACT

For notifying information on points effectively to, for example, people who have not purchased goods for a long term to achieve the promotion of utilization of a point service which leads to the promotion of purchase of goods (for example, promotion of utilization of cards), a point service provider side computer connected through a network to customer terminals reads out customer identification information on customers who have not purchased goods for a first predetermined period of time, from a purchase history file on the basis of purchase date information, reads out the total number of points from a point management file on the basis of the customer identification information, reads out exchangeable goods information from an exchangeable-goods information file on the basis of the total number of points, and edits a message including the total number of points and the exchangeable goods information. This message is transmitted to the customer terminal specified on the basis of the customer identification information.

### BACKGROUND OF THE INVENTION

(1) Field of the Invention

The present invention relates to a point notification method, point notification system and computer-readable recording medium in which a point notification program is recorded, suitable for the notification of information on points (point information) to customers for use in point services in which a predetermined number of points is given as a function of a sum (amount of money) on the purchase of goods, for example, when the goods are purchased through the utilization of a card, and the number of gotten points is available for the exchange for new goods.

(2) Description of the Related Art

So far, for example, as a point service a card company has performed, it is in a general way that, when a member (customer) purchased goods with his/her card, the information on the points is notified to the member in a manner that the present total number of points accumulated presently for the member, the term of validity on the points, and others are written in a bill to be sent to the member and an exchangeable-goods list showing goods exchangeable for the number of points is forwarded thereto together with that bill.

There is no service which notifies point information positively to members who do not use his/her card.

Therefore, a member confirms the present total number of points written in a bill and sees an exchangeable-goods list to, if there is desired goods, select the desired goods from the goods exchangeable for the present total number of points, and writes the present total number of points, the desired goods and others in a predetermined blank for requesting the exchange of the points for the goods.

However, in the conventional point notification method of notifying the information such as the present total number of points and the exchangeable-goods list together with a bill, since the bill is forwarded only when the member purchased goods through the utilization of his/her card, the member cannot acquire the point information such as the present total number of points and the exchangeable-goods list until using his/her card for the purchase of goods.

For example, as a matter of course, a bill does not arrive at a member who does not use his/her card over a long term and the point information also does not arrive thereat; in consequence, the member not only can forget the presence of the point service but also can forget the fact that he/she is a card member.

On the other hand, for a card company, it is an important object to fulfill effective functions of the point service for urging a member, who has not used the card for a long term, to promote the card utilization.

In addition, even a member who sometimes uses the card cannot receive a bill if no purchase of goods is made with his/her card when the time is approaching the term of validity and, hence, cannot get the point information; as a result, there is a possibility that the term of validity expires before the member realizes the term of validity so that difficulty is experienced in making the exchange of the points for goods. Accordingly, the point service does not function well, which makes the card remote from the promotion of use.

Meanwhile, for members, the recent spread of the internet is now at hand to gain access to, for example, the home page (Web page) of the card company to confirm an exchangeable-goods list or to input a card number, a cipher number and others for confirming the present total number of points and for requesting the exchange of the points for goods.

However, according to this method, only a member who tries to acquire the point information positively can gain the point information such as the present total number of points and an exchangeable-goods list. Since it is considered that, even prior to the spread of the internet, such a member can gain the point information, for example, by inquiring for it at the card company through the use of telephone or the like, the acquisition of the point information through the internet signifies only the improvement of convenience for the positive members.

Furthermore, such a member who tries to acquire the point information positively has an interest in the point service and is considered to be a member who purchases goods while using his/her card positively, in this case, no large necessity exists that achieves the promotion of utilization of point service or the promotion of utilization of his/her card.

On the other hand, since a member who does not use his/her card for a long term is considered to be a member who does not use his/her card very positively, it is not readily considered that such a member gains access to the home page of the card company for acquiring the point information positively. For this reason, even if the point information is obtainable through a network as mentioned above, difficulty is encountered in eliminating a situation in which a member who has not used his/her card for a long term forgets the presence of the point service or forgets the fact that he/she is a card member.

In addition, since there are many cases in which a member who has not purchased goods with a card until the time is close on the expiration of the term of validity have forgotten the point service, it is not readily considered that such a member gains access to the homepage of the card company for acquiring the point information positively. Accordingly, likewise, even if the point information is obtainable through a network as mentioned above, the term of validity expires without paying attention to the term of validity on the points so that difficulty is experienced in making the exchange of the points for goods.

### SUMMARY OF THE INVENTION

The present invention has been developed in consideration of these problems, and it is therefore an object of the invention to provide a point notification method, point notification system and computer-readable recording medium retaining a point notification program, which are capable of notifying effectively information on points (for example, information including the present total number of points and exchangeable-goods list) to, for example, people who have not purchased goods over a long term or people who have not purchased goods when the time is approaching the expiration of the term of validity on the points, thus promoting the utilization of a point service, which in turn achieves the promotion of purchase of goods (for example, the promotion of utilization of cards)

In accordance with the present invention, there is provided a point notification method of notifying information on points to customers who have a right to utilize a point service, through the use of a point service provider side computer connected through a network to customer terminals, the method comprising a customer identification information readout step in which the computer reads out customer identification information on a customer, who has not purchased goods for a first predetermined period of time, on the basis of purchase date information from a purchase history file storing the customer identification information and the purchase date information in a state associated with each other, a total point readout step in which the computer reads out the total number of points on the basis of the customer identification information from a point management file storing the customer identification information and the total number of points in a state associated with each other, an exchangeable-goods information readout step in which the computer reads out exchangeable goods information on the basis of the total number of points from an exchangeable-goods information file storing the number of points and the exchangeable goods information in a state associated with each other, a message edit step in which the computer edits a message including the total number of points and the exchangeable goods information, and a message transmission step in which the computer transmits the message to the customer terminal specified on the basis of the customer identification information.

In addition, in accordance with the present invention, there is provided a point notification method of notifying information on points to customers who have a right to utilize a point service, through the use of a point service provider side computer connected through a network to customer terminals, the method comprising a customer identification information/total point readout step in which the computer reads out customer identification information and the total number of points corresponding to the customer identification information from a point management file storing the customer identification information and the total number of points in a state associated with each other, an exchangeable-goods information readout step in which the computer reads out information on exchangeable goods for the number of points one grade higher than the total number of points from an exchangeable-goods information file storing the number of points and exchangeable goods information in a state associated with each other, a message edit step in which the computer edits an message including the total number of points and the exchangeable goods information, and a message transmission step in which the computer transmits the message to the customer terminal specified on the basis of the customer identification information.

Still additionally, in accordance with the present invention, there is provided a point notification method of notifying information on points to customers who have a right to utilize a point service, through the use of a point service provider side computer connected through a network to customer terminals, the method comprising a customer identification information/total point readout steps in which the computer reads out customer identification information and the total number of points corresponding to the customer identification information from a point management file, storing the customer identification information and the total number of points in a state associated with each other, a second predetermined period of time before the expiration of the term of point validity set equally with respect to all points, an exchangeable-goods information readout step in which the computer reads out exchangeable goods information on the basis of the total number of points from an exchangeable-goods information file storing the number of points and the exchangeable goods information in a state associated with each other, a message edit step in which the computer edits an message including the total number of points and the exchangeable goods information, and a message transmission step in which the computer transmits the message to the customer terminal specified on the basis of the customer identification information.

Moreover, in accordance with the present invention, there is provided a point notification method of notifying information on points to customers who have a right to utilize a point service, through the use of a point service provider side computer connected through a network to customer terminals, the method comprising a customer identification information readout step in which the computer reads out customer identification information on a customer, who has points a second predetermined period of time before the expiration of the term of point validity, on the basis of purchase date information from a purchase history file storing the customer identification information and the purchase date information in a state associated with each other, a total point readout step in which the computer reads out the total number of points on the basis of the customer identification information from a point management file storing the customer identification information and the total number of points in a state associated with each other, an exchangeable-goods information readout step in which the computer reads out exchangeable goods information on the basis of the total number of points from an exchangeable-goods information file storing the number of points and the exchangeable goods information in a state associated with each other, a message edit step in which the computer edits an message including the total number of points and the exchangeable goods information, and a message transmission step in which the computer transmits the message to the customer terminal specified on the basis of the customer identification information.

Preferably, the point notification method includes a category readout step in which the computer reads out a category of purchased goods by each customer from a purchase history file storing the customer identification information and the category in a state associated with each other, on the basis of the customer identification information read out in the customer identification information readout step or in the customer identification information/total point readout step, and in the exchangeable-goods information readout step, the computer reads out the exchangeable goods information on the basis of the category and the total number of points from the exchangeable-goods information file storing the number of points, the category and the exchangeable goods information in a state associated with each other.

Moreover, preferably, in the message edit step, the computer edits the message including link information linked to a home page putting information on a point service.

Furthermore, in accordance with the present invention, there is provided a point notification system connected through a network to customer terminals for notifying information on points to customers who have a right to utilize a point service, the system comprising customer identification information readout means for reading out customer identification information on customers, who have not purchased goods for a first predetermined period of time, on the basis of purchase date information from a purchase history file storing the customer identification information and the purchase date information in a state associated with each other, total point readout means for reading out the total number of points on the basis of the customer identification information from a point management file storing the customer identification information and the total number of points in a state associated with each other, exchangeable-goods information readout means for reading out exchangeable goods information on the basis of the total number of points from an exchangeable-goods information file storing the number of points and the exchangeable goods information in a state associated with each other, message editing means for editing a message including the total number of points and the exchangeable goods information, and message transmission means for transmitting the message to the customer terminal specified on the basis of the customer identification information.

Still furthermore, in accordance with the present invention, there is provided a point notification system connected through a network to customer terminals for notifying information on points to customers who have a right to utilize a point service, the system comprising customer identification information/total point readout means for reading out customer identification information and the total number of points corresponding to the customer identification information from a point management file storing the customer identification information and the total number of points in a state associated with each other, exchangeable-goods information readout means for reading out information on exchangeable goods for the number of points one grade higher than the total number of points from an exchangeable-goods information file storing the number of points and the exchangeable goods information in a state associated with each other, message editing means for editing an message including the total number of points and the exchangeable goods information, and message transmission means for transmitting the message to the customer terminal specified on the basis of the customer identification information.

Yet furthermore, in accordance with the present invention, there is provided a point notification system connected through a network to customer terminals for notifying information on points to customers who have a right to utilize a point service, the system comprising customer identification information/total point readout means for reading out customer identification information and the total number of points corresponding to the customer identification information from a point management file, storing the customer identification information and the total number of points in a state associated with each other, a second predetermined period of time before the expiration of the term of point validity set equally with respect to all points, exchangeable-goods information readout means for reading out exchangeable goods information on the basis of the total number of points from an exchangeable-goods information file storing the number of points and the exchangeable goods information in a state associated with each other, message editing means for editing an message including the total number of points and the exchangeable goods information, and message transmission means for transmitting the message to the customer terminal specified on the basis of the customer identification information.

Moreover, in accordance with the present invention, there is provided a point notification system connected through a network to customer terminals for notifying information on points to customers who have a right to utilize a point service, the system comprising customer identification information readout means for reading out customer identification information on a customer, who has points a second predetermined period of time before the expiration of the term of point validity, on the basis of purchase date information from a purchase history file storing the customer identification information and the purchase date information in a state associated with each other, total point readout means for reading out the total number of points on the basis of the customer identification information from a point management file storing the customer identification information and the total number of points in a state associated with each other, exchangeable-goods information readout means for reading out exchangeable goods information on the basis of the total number of points from an exchangeable-goods information file storing the number of points and the exchangeable goods information in a state associated with each other, message editing means for editing an message including the total number of points and the exchangeable goods information, and message transmission means for transmitting the message to the customer terminal specified on the basis of the customer identification information.

Preferably, the point notification system includes category readout means for reading out a category of purchased goods by each customer from a purchase history file storing the customer identification information and a category in a state associated with each other on the basis of the customer identification information read out by the customer identification information readout means or in the customer identification information/total point readout means, and the exchangeable-goods information readout means reads out the exchangeable goods information on the basis of the category and the total number of points from an exchangeable-goods information file storing the number of points, the category and the exchangeable goods information in a state associated with each other.

Moreover, preferably, the message editing means edits the message including link information linked to a home page carrying information on a point service.

In addition, in accordance with the present invention, there is provided a computer-readable recording medium in which a point notification program, for notifying information on points to customers who have a right to utilize a point service, is stored, wherein the point notification program instructs the computer to execute the following steps of a customer identification information readout step of reading out customer identification information on customers, who have not purchased goods for a first predetermined period of time, on the basis of purchase date information from a purchase history file storing the customer identification information and the purchase date information in a state associated with each other, a total point readout step of reading out the total number of points on the basis of the customer identification information from a point management file storing the customer identification information and the total number of points in a state associated with each other, an exchangeable-goods information readout step of reading out exchangeable goods information on the basis of the total number of points from an exchangeable goods information file storing the number of points and the exchangeable-goods information in a state associated with each other, a message edit step of editing a message including the total number of points and the exchangeable goods information, and a message transmission step of transmitting the message on the basis of the customer identification information.

Still additionally, in accordance with the present invention, there is provided a computer-readable recording medium in which a point notification program, for notifying information on points to customers who have a right to utilize a point service, is stored, wherein the point notification program instructs the computer to execute the following steps of a customer identification information/total point readout step of reading out customer identification information and the total number of points corresponding to the customer identification information from a point management file storing the customer identification information and the total number of points in a state associated with each other, an exchangeable-goods information readout step of reading out information on exchangeable goods for the number of points one grade higher than the total number of points from an exchangeable-goods information file storing the number of points and exchangeable goods information in a state associated with each other, a message edit step of editing an message including the total number of points and the exchangeable goods information, and a message transmission step of transmitting the message through a network to a customer terminal on the basis of the customer identification information.

Yet additionally, in accordance with the present invention, there is provided a computer-readable recording medium in which a point notification program, for notifying information on points to customers who have a right to utilize a point service, is stored, wherein the point notification program instructs the computer to execute the following steps of a customer identification information/total point readout steps of reading out customer identification information and the total number of points corresponding to the customer identification information from a point management file, storing the customer identification information and the total number of points in a state associated with each other, a second predetermined period of time before the expiration of the term of point validity set equally with respect to all points, an exchangeable-goods information readout step of reading out exchangeable goods information on the basis of the total number of points from an exchangeable-goods information file storing the number of points and the exchangeable goods information in a state associated with each other, a message edit step of editing an message including the total number of points and the exchangeable goods information, and a message transmission step of transmitting the message through a network to a customer terminal on the basis of the customer identification information.

Moreover, in accordance with the present invention, there is provided a computer-readable recording medium in which a point notification program, for notifying information on points to customers who have a right to utilize a point service, is stored, wherein the point notification program instructs the computer to execute the following steps of a customer identification information readout step of reading out customer identification information on a customer, who has points a second predetermined period of time before the expiration of the term of point validity, on the basis of purchase date information from a purchase history file storing the customer identification information and the purchase date information in a state associated with each other, a total point readout step of reading out the total number of points on the basis of the customer identification information from a point management file storing the customer identification information and the total number of points in a state associated with each other, an exchangeable-goods information readout step of reading out exchangeable goods information on the basis of the total number of points from an exchangeable-goods information file storing the number of points and the exchangeable goods information in a state associated with each other, a message edit step of editing an message including the total number of points and the exchangeable goods information, and a message transmission step of transmitting the message through a network to a customer terminal on the basis of the customer identification information.

Furthermore, in accordance with the present invention, preferably, there is provided a point notification system used for notifying information on points to customers who have a right to utilize a point service, the system comprising customer identification information readout means for reading out customer identification information on customers, who have not purchased goods for a first predetermined period of time, on the basis of purchase date information from a purchase history file storing the customer identification information and the purchase date information in a state associated with each other, total point readout means for reading out the total number of points on the basis of the customer identification information from a point management file storing the customer identification information and the total number of points in a state associated with each other, exchangeable-goods information readout means for reading out exchangeable goods information on the basis of the total number of points from an exchangeable-goods information file storing the number of points and the exchangeable goods information in a state associated with each other, message editing means for editing a message including the total number of points and the exchangeable goods information, and outputting means for outputting the message with respect to the customer identification information.

Still furthermore, in accordance with the present invention, preferably, there is provided a point notification system comprising customer identification information/total point readout means for reading out customer identification information and the total number of points corresponding to the customer identification information from a point management file storing the customer identification information and the total number of points in a state associated with each other, exchangeable-goods information readout means for reading out information on exchangeable goods for the number of points one grade higher than the total number of points from an exchangeable-goods information file storing the number of points and exchangeable goods information in a state associated with each other, message editing means for editing an message including the total number of points and the exchangeable goods information, and outputting means for outputting the message with respect to the customer identification information.

Moreover, in accordance with the present invention, preferably, there is provided a point notification system comprising customer identification information/total point readout means for reading out customer identification information and the total number of points corresponding to the customer identification information from a point management file, storing the customer identification information and the total number of points in a state associated with each other, a second predetermined period of time before the expiration of the term of point validity set equally with respect to all points, exchangeable-goods information readout means for reading out exchangeable goods information on the basis of the total number of points from an exchangeable-goods information file storing the number of points and the exchangeable-goods information in a state associated with each other, message editing means for editing an message including the total number of points and the exchangeable goods information, and outputting means for outputting the message with respect to the customer identification information.

Still moreover, in accordance with the present invention, preferably, there is provided a point notification system comprising customer identification information readout means for reading out customer identification information on a customer, who has points a second predetermined period of time before the expiration of the term of point validity, on the basis of purchase date information from a purchase history file storing the customer identification information and the purchase date information in a state associated with each other, total point readout means for reading out the total number of points on the basis of the customer identification information from a point management file storing the customer identification information and the total number of points in a state associated with each other, exchangeable-goods information readout means for reading out exchangeable goods information on the basis of the total number of points from an exchangeable-goods information file storing the number of points and the exchangeable goods information in a state associated with each other, message editing means for editing an message including the total number of points and the exchangeable goods information, and outputting means for outputting the message with respect to the customer identification information.

A point notification method, point notification system and computer-readable recording medium retaining a point notification program according to the present invention enable the point information (for example, information such as the present total number of points and an exchangeable-goods list) to be effectively notified to people who have not purchased goods for a long term or to people who have not purchased goods when the time is approaching the expiration of the term of point validity, thus facilitating the utilization of a point service to contribute to the promotion of purchase of goods (promotion of the utilization of cards).

### BRIEF DESCRIPTION OF THE DRAWINGS

FIG. 1 is a block diagram showing the entire configuration of a point notification system according to the first embodiment of the present invention;

FIG. 2 is a block diagram showing a configuration of a point service provider side computer for realizing the point notification system according to the first embodiment of the present invention;

FIG. 3 is a block diagram showing a configuration of a point service system according to the first embodiment of the present invention;

FIG. 4 is an illustration of the contents of a purchase history file stored by on the point notification system according to the first embodiment of the present invention;

FIG. 5 is an illustration of the contents of a point management file stored by on the point notification system according to the first embodiment of the present invention;

FIG. 6 is an illustration of the contents of an exchangeable-goods information file stored by on the point notification system according to the first embodiment of the present invention;

FIG. 7 is an illustration of the contents of a member information file stored by on the point notification system according to the first embodiment of the present invention;

FIG. 8 is a flow chart showing a procedure for point notification processing (point notification method) based on the point notification system according to the first embodiment of the present invention; and

FIG. 9 is an illustration of a message notified by the point notification system according to the first embodiment of the present invention (an illustration of a state appearing on a display screen of a member terminal).

### DESCRIPTION OF THE PREFERRED EMBODIMENTS

Referring to the drawings, a description will be given hereinbelow of a point notification method, point notification system and computer-readable recording medium retaining a point notification program according to an embodiment of the present invention.

The present invention is for, in a point service in which a predetermined number of points is given as a function of a sum on the purchase of goods when the goods are purchased and the number of points accumulated is available for the exchange for corresponding goods, notifying point information (for example, information such as the present total number of points and an exchangeable-goods list) effectively to, for example, people who has not purchased goods over a long term or to people who have not purchased goods (for example, people who have not utilized his/her card) at the time when the expiration of the term of validity approaches.

(Description of First Embodiment)

First of all, a description will be given of an example of a point service, a card company performs, as a point notification system and point notification method according to the first embodiment of the present invention.

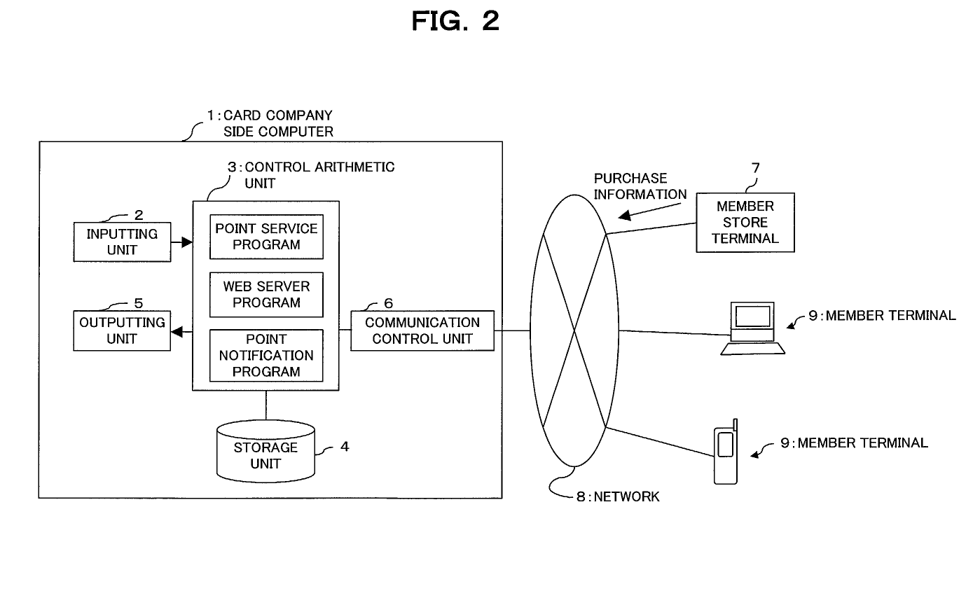

In this embodiment, as FIG. 2 shows, a card company side computer (point service provider side computer) 1 located in a card company serving as a point service provider is made up of an inputting unit (inputting means) 2 such as a keyboard, a control arithmetic unit (control arithmetic means) 3 including a CPU (Central Processing Unit), a memory and others, a storage unit (storage means) 4 such as a hard disk, an outputting unit (outputting means) 5 such as a display or printer, a communication control unit (communication control means) 6 such as a modem, and other units.

The storage unit 4 retains various types of files (databases) including a point management file, a purchase history file, an exchangeable-goods information file and a member information file (customer information file), a program file accommodating predetermined programs, and others, while the control arithmetic unit 3 reads and implements the programs from the program file to execute various kinds of processing which will be mentioned later.

In this case, as FIG. 2 shows, the card company side computer 1 reads and implements programs such as a point service program for conducting the processing to offer a point service, a web server program for offering a home page (web site) of the card company and a point notification program for offering a point notification service.

Although the card company side computer is shown as one computer in FIG. 2 (in this case, the card company side computer is equally referred to as a web server because the web server program is installed therein), the present invention is not limited to this, but it is also appropriate that the card company side computer is made with a computer system comprising a plurality of groups of computers. For example, in this case, it is also possible that the web server program is installed in one computer to configure a web server while the point service program and the point notification program are installed in another computer to provide a point processing computer (point processing system).

The card company side computer 1, thus configured, is connected through a network (communication network; for example, communication network such as the internet, a dedicated line or a public line) 8 to a computer (member store computer, member store terminal) 7 located in a member store such as a hotel, restaurant or shop, as shown in FIG. 2.

In addition, in a case in which a member (customer, user) has purchased goods in a member store through the use of his/her card, this purchase information (sales information) is transmitted from the member store terminal 7 through the network 8 to the card company side computer 1.

In particular, in order to offer a point service in which a predetermined number of points is given as a function of a sum for goods purchased and, when the total number of points reaches a predetermined point number, the points are exchanged for goods corresponding to the number thereof, the control arithmetic unit 3 of the card company side computer 1 reads and executes the point service program to conduct a point service processing comprising the following processes.

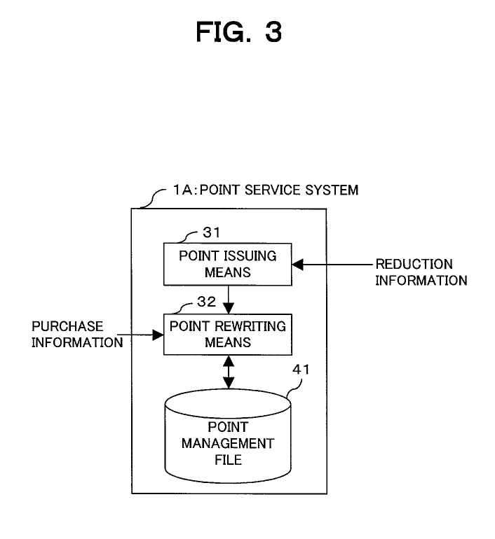

Since the point service processing is conducted by implementing the point service program in the control arithmetic unit 3 of the card company side computer 1 as mentioned above, as the functions to conduct the point service processing, the card company side computer 1 is equipped with a point issuing means 31 and a point rewriting means 32 as shown in FIG. 3. That is, the functions of the card company side computer 1 realizes a point service system 1A.

In this configuration, the point issuing means 31 is for conducting the processing (point issue processing) to issue predetermined points on the basis of a sum for goods purchased. For example, the point issuing means 31 refers to a sum-point table, made out to indicate predetermined points for each of sums, to issue points as a function of the sum for the goods purchased, for example, issue 1000 points if the sum for goods purchased is 1000 yens.

In this case, when purchase information inputted through an inputting means (purchase information inputting means) of a member store terminal 7 is transmitted through the network 8 and inputted through a communication control unit 6 to the control arithmetic unit 3 of the card company side computer 1, the control arithmetic unit 3 implements the point service program. That is, as FIG. 3 shows, the point issuing means 31 is made to conduct the point issue processing upon receipt of the purchase information from the member store terminal 7.

The point rewriting means 32 is for conducting the processing (point rewrite processing) to rewrite the total number of points (accumulated points), recorded in a point management file 41, on the basis of the number of points issued lately by the point issuing means 31.

For example, the point rewrite means 32 reads out the present total number of points of that member from the point management file 41 on the basis of a member number (member identification information, customer identification information) included in the purchase information from a member store to add the number of points, issued lately by the point issuing means 31, to the present total number of points read out therefrom for calculating a new number of points so that the present total number of points is rewritten with the new total number of points.

On the other hand, in a case in which a member requests the exchange of a given number of points for goods, the control arithmetic unit 3 of the card company side computer 1 implements the point service program to conduct the processing (point rewrite processing) to rewrite the total number of points, placed in the point management file 41, on the basis of the number of points (referred to as “reduced points”) used for the exchange for the goods. Incidentally, this processing is referred to equally as reduction processing and this function is referred to equally as a point reducing means.

In this connection, in a case in which the request for the exchange for the goods is made through the use of FAX, telephone, document by mail, or the like, an operator belonging to the card company inputs necessary information (reduction information) such as the number of points to be used for the exchange for goods through the inputting unit 2 of the card company side computer 1 for implementing the point service program. Moreover, in a case in which the request for the exchange for goods is made through the network 8, the exchange-for-goods request information (reduction information) is transmitted from a member terminal 9 through the network 8 and when it is inputted through the communication control unit 6 to the control arithmetic unit 3 of the card company side computer 1, the point service program is implemented. In this case, for reasons of the exchange-for-goods request information being inputted through the inputting unit of the member terminal 9, the inputting unit of the member terminal 9 is referred to as a reduction information inputting means.

In this embodiment, when the reduction information is inputted to the point rewrite means 32, the point rewrite means 32 reads out the present total number of points of that member from the point management file 41 on the basis of the member number (member identification information, customer identification information) included in the purchase information from a member store to subtract the number of points used for the exchange for the goods from the present total number of points read out therefrom for calculating a new number of points so that the present total number of points is replaced with the new total number of points.

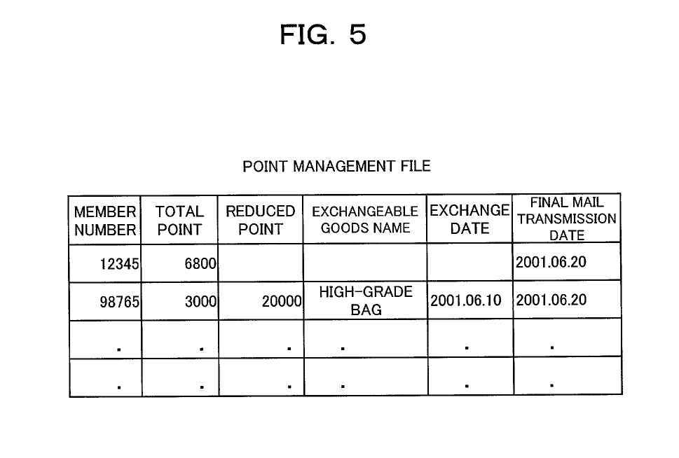

Furthermore, in this connection, in a case in which a member makes a request for the exchange of accumulated points for goods, the card company side computer 1 implements the point service program to conduct the processing (point reduction information write processing) to write, in the point management file 41, the information such as the number of reduced points, the exchanged goods names, the exchange date included in the exchange-for-goods request information. The point management file 41 in which various kinds of information are written in this way is, for example, as shown in FIG. 5.

According to this embodiment, as mentioned above, the control arithmetic unit 3 of the card company side computer 1 conducts the processing such as point issue processing, point rewrite processing and point reduction information write processing, thereby managing the points of each member.

Moreover, as FIG. 2 shows, the card company side computer 1 functions as a web server, for that the control arithmetic unit 3 thereof executes the web server program.

Still moreover, this card company side computer 1 is connected through the network (communication network) 8 to a terminal (member terminal, customer terminal, user terminal) 9 such as a personal computer or a portable telephone (portable type mobile unit, portable type mobile terminal) with a data display function (web display function), situated on a member (customer) side.

Therefore, the member has access through an address (URL: Uniform Resource Locator) to a home page (web page, web site) carrying information such as the point service stored in the card company side computer 1 (web server) for, for example, confirming the present total number of points, confirming an exchangeable-goods list or taking a procedure for the exchange for goods.

Meanwhile, for the purpose of the promotion of the utilization of the point service which leads to the promotion of the card utilization, an effective approach is to notify the point information (for example, the information such as the present total number of points and an exchangeable-goods list) to, for example, people who have not purchased goods through the use of their cards over a long term.

Thus, in this embodiment, in the card company side computer 1, the control arithmetic unit 3 executes the point notification program for conducting the processing (point notification processing) to notify the points to a member as shown in FIG. 2.

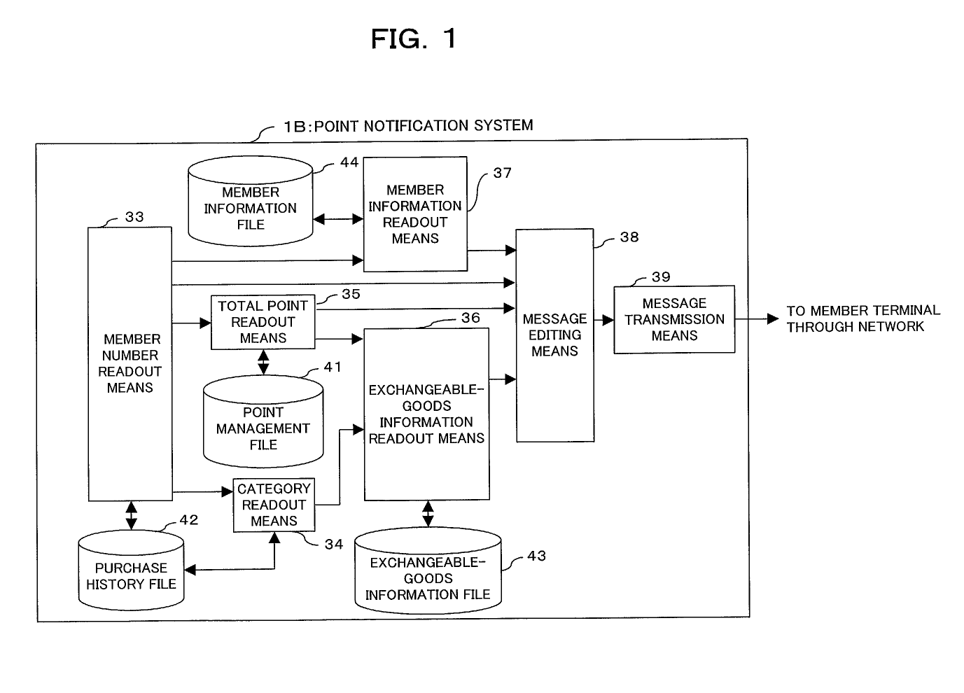

For reasons of the point notification program being implemented in the control arithmetic unit 3 of the card company side computer 1 to conduct the point notification processing, as the functions to conduct the point notification processing, the card company side computer 1 comprises a member number readout means 33, a category readout means 34, a total point readout means 35, an exchangeable-goods information readout means 36, a member information readout means 37, a message editing means 38 and a message transmission means 39, as shown in the functional block diagram of FIG. 1. That is, the functions of the card company side computer 1 realize a point notification system 1B composed of the above-mentioned means 33 to 39.

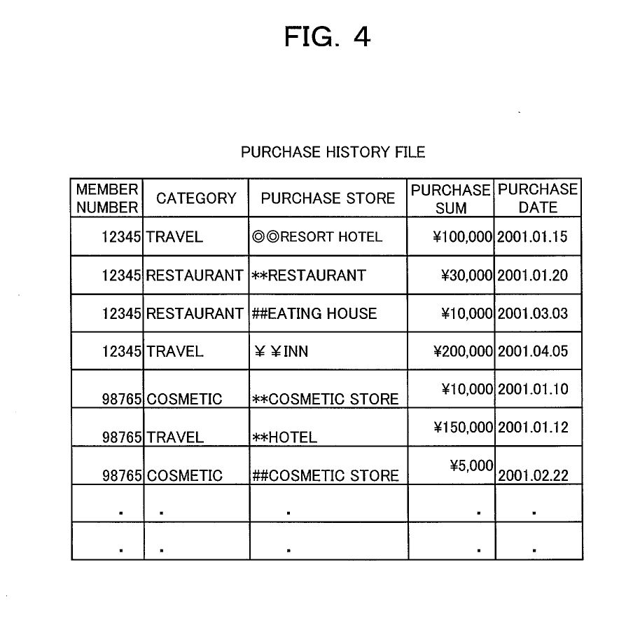

The member number readout means (member identification information readout means, customer identification information readout means) 33 is for conducting the processing to read out a member number of a member (notified member, notified customer), who has not purchased goods for a predetermined period of time (for a first predetermined period of time), from a purchase history file (purchase history storage unit; see FIG. 4) 42 in which information such as member numbers (member identification information, customer identification information; for example, card numbers or the like), categories, purchase store names (used store names), purchase sums (used sums) and purchase dates (use dates) are stored in a state associated with each other. The member number of the notified object read out therefrom is used in the point readout means 35, the category readout means 34, the member information readout means 37 and the message editing means 38.

The total point readout means (point management means) 35 is for reading out the present total number of points, given to a member of the notified object, on the basis of the member number of the notified object from a point management file (point storage unit; see FIG. 5) 41 in which information such as member numbers, total points, reduced points, exchangeable goods names, exchange dates and final mail send dates are stored in a state associated with each other. The total number of points read out therefrom is used in the exchangeable-goods information readout means 36 and the message editing means 38.

The category readout means 34 is for conducting the processing to read out a category of the goods purchased by the member of the notified object, as a category of goods suiting the taste of the member of the notified object (goods interesting greatly to the member) from a purchase history file (see FIG. 4) 42 on the basis of the member number of the notified object. The purchased goods category read out therefrom is used in the exchangeable-goods information readout means 36

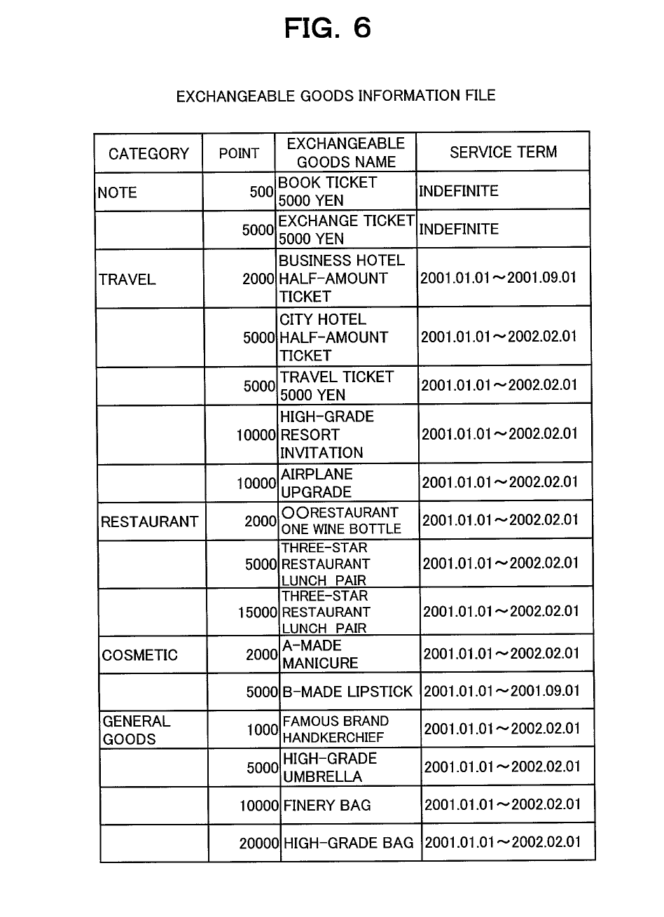

The exchangeable-goods information readout means 36 is for conducting the processing to read out information (exchangeable goods information; exchangeable goods name) about goods, exchangeable for the present total number of points for the member of the notified object, on the basis of the present total number of points for the member of the notified object and the category of the purchased goods from an exchangeable-goods information file (exchangeable-goods information storage unit; see FIG. 6) 43 in which information such as categories, points, exchangeable goods names and service terms are stored in a state associated with each other. The exchangeable goods name read out therefrom is used in the message editing means 38.

For example, the exchangeable-goods information readout means 36 is designed to read out, as an exchangeable goods name(s), a name(s) of goods exchangeable for the number of points one grade higher than the present total number of points for a member of the notified object and belonging to the same category as that of the goods purchased by the same member. In this connection, it is also acceptable that the exchangeable-goods information readout means 36 is made to read out a name(s) of goods exchangeable for the present total number of points for a member of the notified object and belonging to the same category as that of the goods purchased by the same member.

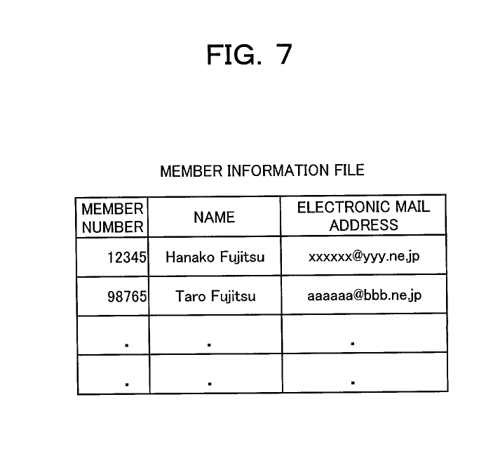

The member information readout means (customer information readout means) 37 is for conducting the processing to read out information about a member of the notified object (member information; for example, name, electronic mail address or the like of the member of the notified objected) from a member information file (member information storage unit; see FIG. 7) 44 on the basis of the member number of the notified object. The member information read out therefrom is used in the message editing means 38.

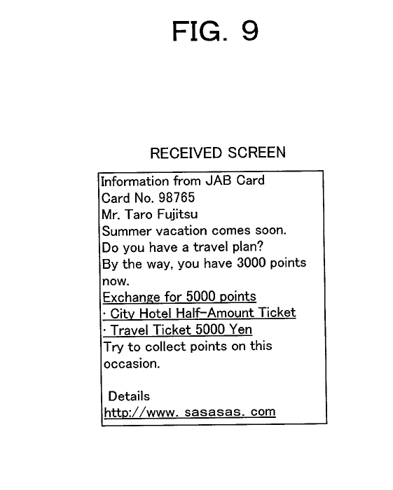

The message editing means 38 is for conducting the processing to edit a message on the basis of information such as the member number and name of a member of the notified object, the present total number of points for the member of the notified object and the exchangeable-goods name(s). That is, the message editing means 38 reads out a fixed form of message from a storage means (not shown) to incorporate, into this message form, the information such as the member number of a member of the notified object read out by the member number readout means 33, the name of the member of the notified object read out by the member information readout means 37, the present total number of points for the member of the notified object read out by the total point readout means 35 and the exchangeable goods name(s) read out by the exchangeable-goods information readout means 36, thereby conducting the message editing processing (see FIG. 9).

The message transmission means 39 is for conducting the processing to transmit a message edited in the message editing means 38 through the use of an electronic mail. That is, the message transmission means 39 transmits the message obtained through the editing processing by the message editing means 38 through an electronic mail to a member of the notified object on the basis of an electronic mail address of the member of the notified object read out by the member information readout means 37.

In this embodiment, as FIG. 2 shows, the card company side computer 1 for the realization of the point notification system 1B is connected through the communication control unit 6 to the network (for example, the internet) 8 and the member terminal 9 is also connected to the network 8, and the message [message including the point information (for example, information such as the present total number of points and an exchangeable-goods list) produced through the point notification processing] transmitted by the message transmission means 39 is transmitted through the network 8 to the member terminal 9 by means of the electronic mail.

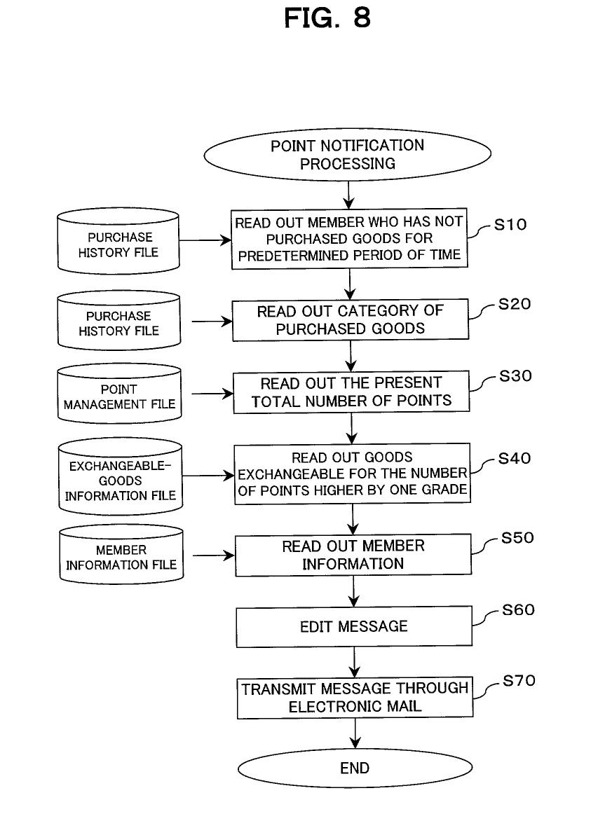

Secondly, referring to the flow chart of FIG. 8, a description will be given hereinbelow of point notification processing (point notification method) to be conducted by the point notification system 1B.

The point notification processing shown in the flow chart of FIG. 8 is conducted in a manner that the control arithmetic unit 3 of the card company side computer 1 implements the point notification program.

In this embodiment, the point notification processing, i.e., the implementation of the point notification program in the control arithmetic unit 3 of the card company side computer 1, takes place every specific time. For example, it is also appropriate that the point notification processing is periodically conducted at a constant interval (for example, each three months), or at irregular intervals.

As FIG. 8 shows, first, at a step S10, in accordance with a point notification program, the control arithmetic unit 3 of the card company side computer 1 reads out a member number of a member (notified object member), who has not purchased goods for a predetermined period of time (first predetermined period of time), from the purchase history file 42 (see FIG. 4) in which information such as member numbers (member identification information, customer identification information; for example, card numbers or the like), categories, purchase store names (use store names), purchase sums (use sums) and purchase dates (use dates) are stored in a state associated with each other (member number readout step, customer identification information readout step). This function of the card company side computer 1 is referred to as a member number readout means (customer identification information readout means) 33 (see FIG. 1).

For example, first, in accordance with the point notification program, the control arithmetic unit 3 of the card company side computer 1 performs the retrieval on the purchase history file shown in FIG. 4 to read out the member number of each member and the date of use by the member. In this case, with respect to the member having a member number “12345”, the use dates “2001.01.15”, “2001.01.20”, “2001.03.03” and “2001.04.05” are readout from the purchase history file shown in FIG. 4. Moreover, with respect to the member having the member number “98765”, the use dates “2001.01.10”, “2001.01.12” and “2001.02.22” are readout therefrom.

Following this, in accordance with the point notification program, the control arithmetic unit 3 of the card company side computer 1 specifies the final date (final use date) of the use dates read out for each member. In this case, for the member numbered as “12345”, the use date “2001.04.05” is specified as the final use date. Moreover, for the member numbered as “98765”, the use date “2001.02.22” is specified as the final use date.

Subsequently, in accordance with the point notification program, the control arithmetic unit 3 of the card company side computer 1 makes a decision as to whether or not the final use date is a date prior to the beginning of a predetermined period of time (first predetermined period of time) ahead of the point notification implementation date. If the decision result shows the final use took place by the predetermined period of time before the point notification implementation date, the control arithmetic unit 3 puts the member number of that member temporarily in a predetermined area of a memory. Thus, only the member numbers of the notified object, who has not purchased goods for the predetermined period of time (first predetermined period of time), are read out in this way.

For example, in a case in which the predetermined period of time (first predetermined period of time) is set to be six months, if the date of the point notification to be implemented lately is Sep. 20, 2001, the date of the beginning of the predetermined period of time (first predetermined period of time) ahead of the point notification implementation date is Mar. 20, 2001, and a decision is made as to whether or not the final use date on each member is before Mar. 20, 2001.

In this case, since the final use date on the member numbered as “98765” is Feb. 22, 2001 preceding Mar. 20, 2001, the member number “98765” is stored temporarily in a predetermined area of a memory. Accordingly, the member with the member number “98765” is treated as the notified object member, and only the member number “98765” is read out. Incidentally, since the final use date on the member with the member number “12345” is Apr. 5, 2001 that does not precede Mar. 20, 2001, the member number “12345” is not read out.

Furthermore, at a step S20, in accordance with the point notification program, on the basis of the member number of the notified object, the control arithmetic unit 3 of the card company side computer 1 reads out a category of goods purchased by the member as a category of goods suiting the taste of the member from the purchase history file shown in FIG. 4 (category readout step). This function of the card company side computer 1 is referred to as a category readout means 34 (see FIG. 1).

For example, first, in accordance with the point notification program, the control arithmetic unit 3 of the card company side computer 1 performs the retrieval on the purchase history file of FIG. 4 by using, as a retrieval key, the member number of the notified object read out at the step S10 to read out a category of goods purchased with respect to each member of the notified object for putting it temporarily in a predetermined area of a memory. Accordingly, the category of the goods purchased by the member of the notified object is read out therefrom.

In this case, since the member having the member number “98765” is handled as the notified object at the step S10 and the member number “98765” is read out, the member number “98765” is used as a retrieval key. Thus, “cosmetic” and “travel” are read out as the category of the goods, purchased by the member having the member number “98765”, from the purchase history file shown in FIG. 4, and are stored temporarily in a predetermined area of a memory.

After this, at a step S30, in accordance with the point notification program, on the basis of the member number of the notified object, the control arithmetic unit 3 of the card company side computer 1 reads out the total number of points as the points presently given to the member of the notified object, from the point management file 41 (see FIG. 5) in which information such as member numbers, total points, reduced points, exchangeable goods names, exchange dates and final mail send dates are stored in a state associated with each other(point readout step). This service computer function is referred to as a point readout means (see FIG. 1).

For example, in accordance with the point notification program, first, the control arithmetic unit 3 of the card company side computer 1 performs the retrieval on the point management file shown in FIG. 5 by using, as a retrieval key, the member number of the notified object read out at the step S10 to read out the total number of points for each member of the notified object for storing it temporarily in a predetermined area of a memory, thus reading out the present total number of points given to the member of the notified object.

In this case, since the member having the member number “98765” is handled as the notified object and the member number “98765” is read out at the above-mentioned step S10, the member number “98765” is used as the retrieval key. Accordingly, “3000” is read out from the point management file shown in FIG. 5 as the total number of points for the member with the member number “98765”, and is temporarily stored in a predetermined area of a memory.

Furthermore, at a step S40, in accordance with the point notification program, on the basis of the present total number of points for a member of the notified object and a category of goods purchased by the member of the notified object, the control arithmetic unit 3 of the card company side computer 1 reads out, together with the number of points higher by one grade, the names (exchangeable goods information, exchangeable goods names) of exchangeable goods exchangeable for the number of points one grade higher than the present total number of points for the member of the notified object and belonging to the same category as that of the goods purchased by the member of the notified object, from the exchangeable-goods information file 43 (see FIG. 6) in which information such as categories, points, exchangeable goods names and service terms are stored in a state associated with each other (exchangeable-goods information readout step). This function of the card company side computer 1 is referred to as an exchangeable-goods information readout means 36 (see FIG. 1).

For example, in accordance with the point notification program, first, the control arithmetic unit 3 of the card company side computer 1 performs the retrieval on the exchangeable-goods information file shown in FIG. 6 by using, as a retrieval key, the category of the goods purchased by a member of the notified object read out at the step S20, thereby reading out the information such as points, exchangeable goods names and service terms, stored in a state associated with the relevant category, with respect to each member of the notified object.

In this case, since the “cosmetic” and “travel” are read out at the aforesaid step S20 as the categories of the goods purchased by the member with the member number “98765”, the “cosmetic” and “travel” are used as the retrieval keys. Accordingly, as the number of points, exchangeable goods name and service term stored in a state associated with “cosmetic”, (1) “2000, “A-made manicure”, “2001.01.01-2002.02.01” and (2) “5000”, “B-made new lipstick”, “2001.01.01-2001.09.01” are read out from the exchangeable-goods information file shown in FIG. 6. In addition, as the number of points, exchangeable goods name and service term stored in a state associated with “travel”, (3) “2000”, “business hotel half-amount ticket”, “2001.01.01-2001.09.01”, (4) “5000”, “city hotel half-amount ticket”, “2001.01.01-2002.02.01”, (5) “5000”, “travel ticket 5000 yen”, “2001.01.01-2002.02.01”, (6) “10000”, “high-grade resort invitation”, “2001.01.1-2002.02.01”, and (7) “10000”, “airplane upgrade”, “2001.01.01-2002.02.01” are read out therefrom.

Still furthermore, the control arithmetic unit 3 specifies, of the points read out, the number of points one grade higher than the present total number of points for the member of the notified object read out at the step S30, and checks the service terms of the exchangeable goods corresponding to the applicable number of points, and if the service term does not expire yet, the number of points higher by one grade and the names of exchangeable goods corresponding to the applicable number of points are stored temporarily in a predetermined area of a memory. Thus, the names of exchangeable goods and the number of points higher by one grade are read out on the basis of the present total number of points given to the member of the notified object.

In this case, the numbers of points (1) “2000”, (2) “5000”, (3) “2000”, (4) “5000”, (5) “5000”, (6) “10000” and (7) “10000” read out in this way are compared with the “3000” read out as the total number of points for the member having the member number “98765”, and the numbers of points (2) “5000”, (4) “5000” and (5) “5000” are selected as the number of points one grade higher than the total number of points “3000”. This specifies the numbers of points higher by one grade.

Then, the control arithmetic unit 3 checks the service terms (2) “2001.01.01-2001.09.01”, (4) “2001.01.01-2002.02.01” and (5) “2001.01.01-2002.02.01” of the exchangeable goods corresponding to the points (2) “5000”, (4) “5000” and (5) “5000” selected. In this case, since the point notification implementation date is Sep. 20, 2001, (4) “city hotel half-amount ticket” and (5) “travel ticket 5000 yen” are selected as the names of the exchangeable goods for which the service terms do not expire. Thus, the names of the exchangeable goods corresponding to the applicable numbers of points are specified.

As a result, (4) “5000”, “city hotel half-amount ticket” and (5) “5000”, “travel ticket 5000 yen” are read out as the numbers of points higher by one grade and the names of the exchangeable goods corresponding to the applicable numbers of points.

Incidentally, in this case, although the goods exchangeable for the number of points one grade higher than the total number of points accumulated presently for the member of the notified object are read out as exchangeable goods, the present invention is not limited to this, but it is also appropriate that the goods exchangeable for the present total number of points for the member of the notified object are read out as the exchangeable goods.

Moreover, in this embodiment, although the exchangeable goods information (exchangeable goods names) are read out in consideration of even the category of the goods the member of the notified object has purchased, the present invention is not limited to this, but it is also appropriate that the exchangeable-goods information is readout on the basis of only the present total number of points for the member of the notified object. In this case, there is no need to conduct the processing at the aforesaid step S20. Still moreover, the processing at the step S40 can be conducted to read out the exchangeable-goods information on the basis of the present total number of points for the member of the notified object read out at the step S30.

In a case in which the exchangeable goods information (exchangeable goods names) is read out on the basis of the present total number of points in no consideration of category as mentioned above, it can be considered that the exchangeable goods do not suit the taste of the member. In this case, for example, a note is used as the exchangeable goods and its amount depends upon the present total number of points.

Subsequently, at a step S50, in accordance with the point notification program, on the basis of the member number of the notified object read out at the step S10, the control arithmetic unit 3 of the card company side computer 1 reads out the name and electronic mail address of the member of the notified object from a member information file 44 (see FIG. 7) in which information on members (member information) such as member numbers, member names and electronic mail addresses are stored in a state associated with each other (member information readout step, customer information readout step). This function of the card company side computer 1 is referred to as a member information readout means (customer information readout means) 37 (see FIG. 1).

For example, first, in accordance with the point notification program, the control arithmetic unit 3 of the card company side computer 1 performs the retrieval on the member information file shown in FIG. 7 by using, as a retrieval key, the member number of the notified object read out at the step S10, and reads out the name and electronic mail address of each member of the notified object to put it temporarily in a predetermined area of a memory. Thus, the name and electronic mail address of the member of the notified object are read out therefrom.

In this case, since the member having the member number “98765” is handled as the member of the notified object and the member number “98765” is read out at the aforesaid step S10, the member number “98765” is used as the retrieval key. Accordingly, from the member information file shown in FIG. 7, “Taro Fujitsu” is read out as the member corresponding to the member number “98765” and “aaaaaa@bbb.ne.jp” is read out as the electronic mail address thereof, and they are stored temporarily in a predetermined area of a memory.

After this, at a step S60, in accordance with the point notification program, the control arithmetic unit 3 of the card company side computer 1 reads out a fixed form of message from a storage means (not shown) to incorporate, into the fixed form of message read out, information such as the member number of the notified object read out at the step S10, the name of the member of the notified object read out at the step S50, the present total number of points for the same member read out at the step S30, and the number of points higher by one grade and the names of exchangeable goods read out at the step S40, thus editing a message (message editing step). This function of the card company side computer 1 is referred to as a message editing means 38 (see FIG. 1).

In this case, the member number “98765” read out at the step S10, “Taro Fujitsu” read out at the step S50, the total number of points read out at the step S30, and the number of points “3000” higher by one grade and names of exchangeable goods (4) “5000”, “city hotel half-amount ticket”, (5) “5000”, “travel ticket 5000 yen” read out at the step S40 are put in the fixed form of message, thereby accomplishing the edition of a message (see FIG. 9).

Then, at a step S70, in accordance with the point notification program, the control arithmetic unit 3 of the card company side computer 1 transmits, through the network (for example, the internet) 8 to the terminal of a member of the notified object, the message edited at the step S60 in the form of an electronic mail on the basis of the electronic mail address of the member of the notified object read out at the step S50 (message transmission step). This function of the card company side computer 1 is referred to as a message transmission means. Moreover, the member terminal 9 has a function to receive the electronic mail.

In this case, through the use of the electronic mail address “aaaaaa@bbb.ne.jp” read out at the step S50, the message is transmitted to the terminal 9 of the member of the notified object who has the member number “98765”. The message transmitted to the member terminal 9 in this way is, for example, as shown in FIG. 9 when being displayed on a display screen thereof. In FIG. 9, the member terminal 9 is a portable telephone, and the message appears on a display screen thereof.

As FIG. 9 shows, link information linked with to the Web page of a card company is included in a fixed form of message. For example, the URL (for example, http://www.sasasas.com) of the Web page (for example, Web page about a point service) of the card company is embedded as a hyper link in the fixed form of message. Accordingly, in a case in which a member sees a message notified through an electronic mail thereto and has an interest in the point service, when the place where the URL is described is only clicked, it jumps to the Web page of the card company of the linked object, so the detailed information about the point service can appear immediately. This enables the promotion of utilization of the point service, leading to the promotion of utilization of cards. Moreover, this enables an increase in access to the Web page of the card company.

In addition, if a procedure for the exchange for goods is made to be done on the Web page of the card company, when a member wants to conduct the exchange for goods using the present total number of points, the member manipulates his/her own terminal 9 to perform a predetermined goods exchange procedure, so it is possible to immediately exchange the points for goods. This enables the secure prevention of the escape of the exchange for goods.

Still additionally, in this embodiment, when the point notification processing is conducted in this way and the electronic mail is sent to the member, the control arithmetic unit 3 of the card company side computer 1 updates the final mail send date column in the point management file shown in FIG. 5 in accordance with the point notification program.

In this case, although “2001.06.20” appears in the final mail send date column of the point management file because the electronic mail was transmitted on the date of the previous point notification implementation (Jun. 20, 2001), this date is updated to “2001.09.20”.

In this connection, in this embodiment, although an message edited is made to be transmitted through an electronic mail, it is also appropriate that, for example, a message edited is printed by a printer acting as an outputting means 5 of the card company side computer 1 and sent by post. In this case, there is no need to read out the electronic mail address of a member of the notified object at the step S50. Moreover, at the step S70, the processing is conducted to output the edited message to the printer of the card company side computer 1.

Thus, with the point notification system and point notification method according to this embodiment, it is possible to notify the information about points positively to a member who has not purchased goods for a predetermined period of time (first predetermined period of time). In particular, the information on points (for example, information such as the present total number of points and a exchangeable-goods list) can be positively and effectively notified to people who have not purchased goods (for example, people who have not utilized their cards) over a long term.

As a result, since it is possible to lead members into using their cards for the purchase of goods exchangeable for the number of points one grade higher than the present point, for example, a point service provider such as a card company has an advantage of promoting the utilization of the point service for the promotion of utilization of the cards (promotion of purchase of goods).

In particular, in this embodiment, since a message including the number of points higher by one grade and goods exchangeable for this number of points is transmitted together with the present total number of points as the point information through the use of an electronic mail, by only manipulating the terminal 9 to receive the electronic mail, the member can easily acquire the useful information on points.

Accordingly, the member can get the point information by seeing the message appearing on the display screen of the terminal 9, which results in arousing his/her desire for further purchase of goods using his/her card, and hence the point service provider such as a card company can lead the member into the use of the card for the purchase of goods, thus realizing the promotion of utilization of the card (promotion of purchase of goods).

In particular, in this embodiment, exchangeable goods extracted in consideration of categories of goods purchased by a member appear on a display, which arouses his/her desire for further purchase of goods and achieves the promotion of utilization of his/her card (promotion of purchase of goods).

Incidentally, in the first embodiment described above, although the point notification is made by reading out member identification information on a member, who has not purchased goods for a predetermined period of time (first predetermined period of time), on the basis of the purchase date information from the purchase history file 42 in which member identification information and purchase date information are stored in a state associated with each other (see the step S10 of FIG. 8), the present invention is not limited to this.

For example, in a case in which information on goods exchangeable for the number of points one grade higher than the total number of points is read out from the exchangeable-goods information file 43 storing the number of points and exchangeable goods information in an associated state, in place of the above-mentioned processing at the step S10 of the flow chart of FIG. 8, it is also appropriate that the member identification information and the total number of points corresponding thereto are read out from a point management file storing the member identification information and the total number of points in an associated state (customer identification information/total point readout step; customer identification information/total point readout means).

(Description of Second Embodiment)

Secondly, a description will be given hereinbelow of a point notification system and point notification method according to a second embodiment of the present invention.

As opposed to the above-described first embodiment in which the point information such as the present total number of points and the exchangeable goods names are notified to, for example, members who have not purchased goods using their cards over a long term, in the second embodiment, the point information such as the present total number of points and the exchangeable goods names are notified to, for example, members who have not purchased goods using their cards when the time is approaching the expiration of the term of validity of points.

Accordingly, in this embodiment, in accordance with a point notification program, the control arithmetic unit 3 of the card company side computer 1 conducts the processing (member number readout step, customer identification information readout step) to read out the member number of a member who has points a predetermined period of time (second predetermined period of time) before the expiration of the term of point validity, on the basis of purchase date information from a purchase history file 42 in which information such as member numbers (member identification information, customer identification information) and purchase dates (use dates) are stored in a state associated with each other (member number readout step, customer identification information readout step). This function is referred to as a member number readout means (customer identification information readout means).

For example, when the term of point validity is set to be a predetermined period of time (for example, one year) after the date of a point issue (for example, the purchase date stored in the purchase history file 42), in place of the processing at the step S10 of the flow chart of FIG. 8 showing the point notification process according to the above-described first embodiment, the processing is conducted as follows. Incidentally, also in this case, as in the case of the above-described first embodiment, the point notification process can be conducted at a specified interval.

In this method, the case of the term of point validity being set as a predetermined period of time (for example one year) after the point issue date includes a case in which the validity term is determined to be a predetermined period of time (for example, one year) after the date of the issue of each point, a case in which the validity term is determined to be a predetermined period of time (for example one year) after the date of the final point issue (the date of the final purchase) for that member, and other cases. In a case in which the validity term is set as a predetermined period of time (for example, one year) from the date of the final point issue (the date of the final purchase) for that member, the validity term of points issued previously is also a predetermined period of time from the date of the final point issue (the date of the final purchase).

First, in accordance with the point notification program, the control arithmetic unit 3 of the card company side computer 1 reads out the member number of a member (notified object), who has points which are approaching the expiration of their validity term, from the purchase history file 42 (see FIG. 4) in which information such as member numbers (member identification information; for example, card numbers or the like), categories, purchase store names (used store names), purchase sums (used amount of money) and purchase dates (use dates) are stored in a state associated with each other (member number readout step, customer identification information readout step). This function of the card company side computer 1 is referred to as a member number readout means (customer identification information readout means).

For example, first, in accordance with the point notification program, the control arithmetic unit 3 of the card company side computer 1 conducts the retrieval on the purchase history file shown in FIG. 4 to read out the member number of each member and the dates of use by the member. In this case, for the member having the member number “12345”, the use dates “2001.01.15”, “2001.01.20”, “2001.03.03” and “2001.04.05” are read out from the purchase history file shown in FIG. 4. Moreover, for the member having the member number “98765”, the use dates “2001.01.10”, “2001.01.12” and “2001.02.22” are read out therefrom.

Subsequently, in accordance with the point notification program, the control arithmetic unit 3 of the card company side computer 1 obtains each term of point validity on the basis of each purchase date. For example, the validity term can be obtained by adding a predetermined period of time (for example, one year) to the purchase date. In this case, for the member numbered as “12345”, each of the validity terms “2002.01.15”, “2002.01.20”, “2002.03.03” and “2002.04.05” is obtained by adding one year to each of the purchase dates “2001.01.15”, “2001.01.20”, “2001.03.03” and “2001.04.05”, while for the member numbered as “98765”, each of the validity terms “2002.01.10”, “2002.01.12” and “2002.02.22” is obtained by adding one year to each of the purchase dates “2001.01.10”, “2001.01.12” and “2001.02.22”.

Then, in accordance with the point notification program, the control arithmetic unit 3 of the card company side computer 1 makes a decision as to whether or not the expiration of each validity term on points given to each member is prior to the date of the elapse of a predetermined period of time (second predetermined period of time; for example, two months) from the point notification implementation date (within the predetermined period of time from the point notification implementation date). If the decision shows the presence of the expiration of the validity term which is prior to the data of the elapse of the predetermined period of time (second predetermined period of time; for example, two months), the member number of the relevant member is temporarily stored in a predetermined area of a memory. Thus, only the member numbers of the members (notified objects) having points immediately before the expiration of the validity term are read out in this way.

For example, if the predetermined period of time (second predetermined period of time) is set to be two months, when the date of the point notification implemented lately is Nov. 11, 2001, the date after the elapse of the predetermined period of time (second predetermined period of time) from the point notification implementation date is Jan. 11, 2002, and hence, a decision is made as to whether the expiration of the point validity term is prior to Jan. 11, 2002.

In this case, since the member numbered as “98765” has a point whose expiration of validity term is prior to Jan. 11, 2002, the member number “98765” is temporarily stored in a predetermined area of a memory. Accordingly, the member numbered as “98765” is handled as a notified object, and only the member number “98765” is read out. On the other hand, since the member numbered as “12345” does not have a point whose expiration of validity term is before Jan. 11, 2002, the readout of the member number “12345” does not take place.

Incidentally, the processing after these processes are the same as the point notification processing (see FIG. 8) according to the above-described first embodiment, and the description thereof will be omitted for brevity.

However, as the exchangeable goods, it is preferable to notify goods exchangeable for the present total number of points. This is because, when the expiration of the term of validity approaches, it is an object to promote the utilization of the point service by stimulating the exchange of points for goods for preventing the point validity term from running out, rather than promoting the utilization of cards by arousing member's desire for purchase of goods. In this case, at the step S40 of the flow chart of FIG. 8 showing the point notification processing according to the above-described first embodiment, the exchangeable goods are read out from the exchangeable-goods information file 43 on the basis of the present total number of points.

Thus, with the point notification system and point notification method according to this embodiment, it is possible to positively and effectively notify point information (for example, information such as the present total number of points and an exchangeable goods list) to even people who has forgotten the accumulation of points, such as people who have not purchased goods at the time when the expiration of the term of validity approaches (for example, people who have not utilized their cards).

Accordingly, members (customers, users) can acquire the point information, and it is possible to prevent the steadily accumulated points from losing because the point validity term runs out before remembering, thus enabling the effective utilization of the point service for the members. This allows the promotion of utilization of the point service, which leads to the promotion of utilization of their cards (promotion of purchase of goods).

In particular, in this embodiment, since the exchangeable goods are displayed in consideration of even the category of the goods purchased by the member, the further desire for purchase can be aroused, thus achieving the promotion of utilization of his/her card (promotion of purchase of goods).

Incidentally, the point notification system, which conducts the point notification processing a predetermined period of time (second predetermined period of time) before the expiration of the term of point validity to notify the point information such as the present total number of points and exchangeable goods names to members, is not limited to the above-described second embodiment.

For example, in a case in which, even if points are gained at any timing within one year, the expiration of the point validity term is equally set as a specified date (for example, February 1) with respect to all the points [that is, if, regardless of the dates of point acquisition (purchase dates), the point validity term is determined to be from February 2 to February 1 in the next year], without conducting the processing at the step S10 of the above-described flow chart, the point notification processing is automatically conducted a predetermined period of time (second predetermined period of time; for example, two months) to notify the point information such as the present total number of points and exchangeable goods names to the member.

In this case, at the step S10 of the flow chart of FIG. 8 showing the point notification processing according to the above-described first embodiment, the control arithmetic unit 3 of the card company side computer 1 conducts the processing (member number/total point readout step, customer identification information/total point readout step) to read out the member number and the total number of point corresponding thereto from the point management file 41 in which member numbers and total points are stored in a state associated with each other. This function is referred to as a member number/total point readout means (customer identification information/total point readout means).

In particular, preferably, the goods exchangeable for the present total number of points are notified as the exchangeable goods. This is because, when the expiration of the term of validity approaches, it is an object to promote the utilization of the point service by stimulating the exchange of points for goods for preventing the point validity term from running out, rather than promoting the utilization of cards by arousing member's desire for purchase.

In this case, at the step S40 of the flow chart of FIG. 8, the exchangeable goods are read out on the basis of the present total number of points from the exchangeable-goods information file 43.

Moreover, in a case in which a message including point information such as the present total number of points and exchangeable goods names was notified through an electronic mail a predetermined period of time (second predetermined period of time; for example, two months) before a specified date (for example, February 1) forming the expiration of the term of point validity in the above-mentioned manner, a message with similar contents can further be notified once or more times through an electronic mail. In particular, it is preferable to increase the frequency of transmission of electronic mail as the expiration of the term of validity approaches. For example, if the first electronic mail transmission is made two months before February 1 forming the expiration of the term of point validity, the transmission of an electronic mail with similar contents is further made one month, a half month, one week, one day before that date. This securely prevents the termination of the term of point validity.

(Description of Point Notification Program and Computer-Readable Recording Medium in which Point Notification Program is Recorded)

Although the description of the point notification system and the point notification method have been made in the first and second embodiments, a program (point notification program) for realizing these point notification system and point notification method can be stored in a recording medium a computer can read, and can be distributed in a state stored in recording media to be put on the market for buying and selling.

In addition, the point notification program stored in the recording medium is installed in a computer, and the computer executes this program, thereby realizing the point notification system and point notification method described above in the embodiments. That is, the point notification program stored in the recording medium can provide the same effects as those of the above-described point notification system and point notification method.

In this case, the recording medium includes memories such as a semiconductor memory, magnetic disks, optical disks (for example, CD-ROM and others), magneto optical disks (MO), magnetic tapes, hard disks, flexible disks, IC cards, ROM cartridges, punch cards, storage units (memory such as RAM and ROM) contained in computers, and external storage units, which can retain the program. Moreover, it is also possible to use various types of computer-readable media such as printed matters on which codes such as bar code is printed. Incidentally, the CD-ROM, MO, Magnetic tape, IC card or the like is referred to as a portable recording medium.

In this connection, the point notification program is not always required to be stored in a computer-readable recording medium, as opposed to the above description. Moreover, the point notification program can also be transmitted (transmitted/received) through a network (communication line, communication network) instead of being stored in the recording medium mentioned above. This enables distributing the point notification program, putting it on the market and buying/selling it. For example, the point notification program can be uploaded into a web server or the like, or downloaded from the web server or the like through a network such as the internet.

(Others)

In the above-described first embodiment, the point information such as the present total number of points and exchangeable goods names are notified to members who have not purchased goods for a predetermined period of time (first predetermined period of time), and in the above-described second embodiments or the modifications thereof, the point notification processing is conducted a predetermined period of time (second predetermined period of time) before the expiration of the term of validity to notify the point information such as the present total number of points and exchangeable goods names to members, with these point notification processing being conducted independently. However, it is also possible to produce a point notification system (point notification method) designed to conduct both the point notification processing.

In addition, it should be understood that the present invention is not limited to the above-described embodiments, and that it is intended to cover all changes and modifications of the embodiments of the invention herein which do not constitute departures from the spirit and scope of the invention.

For example, in the above-described embodiments, although a card company forms a point service provider to offer a point service, the present invention is not limited to this, and the invention is also applicable to similar point services which have been presented by stores such as department stores.

Still additionally, the present invention is also applicable to virtual shopping centers or the like realized on, for example, the internet. In this case, the point notification system (point notification method) according to the above-described embodiment is realized by implementing the point notification program in the web server offering the virtual shopping center, in place of implementing the point notification program in the card company side computer 1.

What is claimed is:

1. A point notification method of notifying information on points to customers who have a right to utilize a point service, through the use of a point service provider side computer connected through a network to customer terminals, said method comprising:
a customer identification information readout step in which said computer reads out customer identification information on a customer, who has not purchased goods for a first predetermined period of time, on the basis of purchase date information from a purchase history file storing said customer identification information and said purchase date information in a state associated with each other;
a total point readout step in which said computer reads out the total number of points on the basis of said customer identification information from a point management file storing said customer identification information and the total number of points in a state associated with each other;
an exchangeable-goods information readout step in which said computer reads out exchangeable goods information on the basis of the total number of points from an exchangeable-goods information file storing the number of points and said exchangeable goods information in a state associated with each other a message edit step in which said computer edits a message including the total number of points and said exchangeable goods information; and
a message transmission step in which said computer transmits said message to said customer terminal specified on the basis of said customer identification information.

2. A point notification method according to claim 1, wherein, in said customer identification information readout step, said computer reads out a customer identification number of a customer, who has not purchased goods for said first predetermined period of time, on the basis of information on the date of the final utilization stored in said purchase history file.

3. A point notification method according to claim 1, wherein, in said exchangeable-goods information readout step, said computer reads out information on goods exchangeable for the number of points one grade higher than the total number of points.

4. A point notification method of notifying information on points to customers who have a right to utilize a point service, through the use of a point service provider side computer connected through a network to customer terminals, said method comprising:
a customer identification information/total point readout step in which said computer reads out customer identification information and the total number of points corresponding to said customer identification information from a point management file storing said customer identification information and the total number of points in a state associated with each other;
an exchangeable-goods information readout step in which said computer reads out information on exchangeable goods for the number of points one grade higher than said total number of points from an exchangeable-goods information file storing the number of points and said exchangeable goods information in a state associated with each other;
a message edit step in which said computer edits an message including the total number of points and said exchangeable goods information; and
a message transmission step in which said computer transmits said message to said customer terminal specified on the basis of said customer identification information.

5. A point notification method according to claim 1, wherein said computer executes point notification processing comprising said steps every specified period of time.

6. A point notification method of notifying information on points to customers who have a right to utilize a point service, through the use of a point service provider side computer connected through a network to customer terminals, said method comprising:
a customer identification information/total point readout steps in which said computer reads out customer identification information and the total number of points corresponding to said customer identification information from a point management file, storing said customer identification information and the total number of points in a state associated with each other, a second predetermined period of time before the expiration of the term of point validity set equally with respect to all points;
an exchangeable-goods information readout step in which said computer reads out exchangeable goods information on the basis of the total number of points from an exchangeable-goods information file storing the number of points and said exchangeable goods information in a state associated with each other;
a message edit step in which said computer edits an message including the total number of points and said exchangeable goods information; and
a message transmission step in which said computer transmits said message to said customer terminal specified on the basis of said customer identification information.

7. A point notification method of notifying information on points to customers who have a right to utilize a point service, through the use of a point service provider side computer connected through a network to each of customer terminals, said method comprising:
a customer identification information readout step in which said computer reads out customer identification information on a customer, who has points a second predetermined period of time before the expiration of the term of point validity, on the basis of purchase date information from a purchase history file storing said customer identification information and said purchase date information in a state associated with each other;
a total point readout step in which said computer reads out the total number of points on the basis of said customer identification information from a point management file storing said customer identification information and the total number of points in a state associated with each other;
an exchangeable-goods information readout step in which said computer reads out exchangeable goods information on the basis of the total number of points from an exchangeable-goods information file storing the number of points and said exchangeable goods information in a state associated with each other;
a message edit step in which said computer edits an message including the total number of points and said exchangeable goods information; and
a message transmission step in which said computer transmits said message to said customer terminal specified on the basis of said customer identification information.

8. A point notification method according to claim 7, wherein, in said customer identification information readout step, said computer reads out customer identification information on a customer who has points said second predetermined period of time before the expiration of the term of point validity, on the basis of information on the date of the first utilization stored in said purchase history file.

9. A point notification method according to claim 6, wherein, in said exchangeable-goods information readout step, said computer reads out information on goods exchangeable for the total number of points.

10. A point notification method according to claim 1, further comprising a category readout step in which said computer reads out a category of purchased goods by each customer from a purchase history file storing said customer identification information and said category in a state associated with each other, on the basis of said customer identification information read out in one of said customer identification information readout step and said customer identification information/total point readout step, in said exchangeable-goods information readout step, said computer reading out said exchangeable goods information on the basis of said category and the total number of points from said exchangeable-goods information file storing the number of points, said category and said exchangeable goods information in a state associated with each other.

11. A point notification method according to claim 1, wherein, in said message edit step, said computer edits said message including link information linked to a home page putting information on a point service.

12. A point notification system connected through a network to customer terminals for notifying information on points to customers who have a right to utilize a point service, said system comprising:
customer identification information readout means for reading out customer identification information on a customer, who has not purchased goods for a first predetermined period of time, on the basis of purchase date information from a purchase history file storing said customer identification information and said purchase date information in a state associated with each other;
total point readout means for reading out the total number of points on the basis of said customer identification information from a point management file storing said customer identification information and the total number of points in a state associated with each other;
exchangeable-goods information readout means for reading out exchangeable goods information on the basis of the total number of points from an exchangeable-goods information file storing the number of points and said exchangeable goods information in a state associated with each other;
message editing means for editing a message including the total number of points and said exchangeable goods information; and
message transmission means for transmitting said message to said customer terminal specified on the basis of said customer identification information.

13. A point notification system according to claim 12, wherein said customer identification information readout means reads out a customer identification number of a customer, who has not purchased goods for said first predetermined period of time, on the basis of information on the date of the final utilization stored in said purchase history file.

14. A point notification system according to claim 12, wherein said exchangeable-goods information readout means reads out information on goods exchangeable for the number of points one grade higher than the total number of points.

15. A point notification system connected through a network to customer terminals for notifying information on points to customers who have a right to utilize a point service, said system comprising:
customer identification information/total point readout means for reading out customer identification information and the total number of points corresponding to said customer identification information from a point management file storing said customer identification information and the total number of points in a state associated with each other;
exchangeable-goods information readout means for reading out information on exchangeable goods for the number of points one grade higher than the total number of points from an exchangeable-goods information file storing the number of points and said exchangeable goods information in a state associated with each other;
message editing means for editing an message including the total number of points and said exchangeable goods information; and
message transmission means for transmitting said message to said customer terminal specified on the basis of said customer identification information.

16. A point notification system according to claim 12, wherein point notification processing by said means is executed every specified period of time.

17. A point notification system connected through a network to customer terminals for notifying information on points to customers who have a right to utilize a point service, said system comprising:
customer identification information/total point readout means for reading out customer identification information and the total number of points corresponding to said customer identification information from a point management file, storing said customer identification information and the total number of points in a state associated with each other, a second predetermined period of time before the expiration of the term of point validity set equally with respect to all points;
exchangeable-goods information readout means for reading out exchangeable goods information on the basis of the total number of points from an exchangeable-goods information file storing the number of points and said exchangeable goods information in a state associated with each other;
message editing means for editing an message including the total number of points and said exchangeable goods information; and
message transmission means for transmitting said message to said customer terminal specified on the basis of said customer identification information.

18. A point notification system connected through a network to customer terminals for notifying information on points to customers who have a right to utilize a point service, said system comprising:
customer identification information readout means for reading out customer identification information on a customer, who has points a second predetermined period of time before the expiration of the term of point validity, on the basis of purchase date information from a purchase history file storing said customer identification information and said purchase date information in a state associated with each other;
total point readout means for reading out the total number of points on the basis of said customer identification information from a point management file storing said customer identification information and the total number of points in a state associated with each other;
exchangeable-goods information readout means for reading out exchangeable goods information on the basis of the total number of points from an exchangeable-goods information file storing the number of points and said exchangeable goods information in a state associated with each other;
message editing means for editing an message including the total number of points and said exchangeable goods information; and
message transmission means for transmitting said message to said customer terminal specified on the basis of said customer identification information.

19. A point notification system according to claim 18, wherein said customer identification information readout means reads out customer identification information on a customer who has points said second predetermined period of time before the expiration of the term of point validity, on the basis of information on the date of the first utilization stored in said purchase history file.

20. A point notification system according to claim 17, wherein said exchangeable-goods information readout means reads out information on goods exchangeable for the total number of points.

21. A point notification system according to claim 12, further comprising category readout means for reading out a category of purchased goods by each customer from a purchase history file storing said customer identification information and said category in a state associated with each other, on the basis of said customer identification information read out by one of said customer identification information readout means and said customer identification information/total point readout means, with said exchangeable-goods information readout means reads out said exchangeable goods information on the basis of said category and the total number of points from said exchangeable-goods information file storing the number of points, said category and said exchangeable goods information in a state associated with each other.

22. A point notification system according to claim 12, wherein said message editing means edits said message including link information linked to a home page putting information on a point service.

23. A computer-readable recording medium in which a point notification program, for notifying information on points to customers who have a right to utilize a point service is stored, wherein said point notification program instructs the computer to execute the following steps of:
a customer identification information readout step of reading out customer identification information on a customer, who has not purchased goods for a first predetermined period of time, on the basis of purchase date information from a purchase history file storing said customer identification information and said purchase date information in a state associated with each other;
a total point readout step of reading out the total number of points on the basis of said customer identification information from a point management file storing said customer identification information and the total number of points in a state associated with each other;
an exchangeable-goods information readout step of reading out exchangeable goods information on the basis of the total number of points from an exchangeable goods information file storing the number of points and said exchangeable-goods information in a state associated with each other;
a message edit step of editing a message including the total number of points and said exchangeable goods information; and
a message transmission step of transmitting said message on the basis of said customer identification information.

24. A computer-readable recording medium according to claim 23, wherein, in said customer identification information readout step, said point notification program makes said computer read out a customer identification number of a customer, who has not purchased goods for said first predetermined period of time, on the basis of information on the date of the final utilization stored in said purchase history file.

25. A computer-readable recording medium according to claim 23, wherein, in said exchangeable-goods information readout step, said point notification program makes said computer read out information on goods exchangeable for the number of points one grade higher than the total number of points.

26. A computer-readable recording medium in which a point notification program, for notifying information on points to customers who have a right to utilize a point service, is stored, wherein said point notification program instructs the computer to execute the following steps of:
a customer identification information/total point readout step of reading out customer identification information and the total number of points corresponding to said customer identification information from a point management file storing said customer identification information and the total number of points in a state associated with each other;
an exchangeable-goods information readout step of reading out information on exchangeable goods for the number of points one grade higher than the total number of points from an exchangeable-goods information file storing the number of points and said exchangeable goods information in a state associated with each other;
a message edit step of editing an message including the total number of points and said exchangeable goods information; and
a message transmission step of transmitting said message through a network to a customer terminal on the basis of said customer identification information.

27. A computer-readable recording medium according to claim 23, wherein said point notification program makes said computer execute point notification processing comprising said steps every specified period of time.

28. A computer-readable recording medium in which a point notification program, for notifying information on points to customers who have a right to utilize a point service, is stored, wherein said point notification program instructs the computer to execute the following steps of:
a customer identification information/total point readout steps of reading out customer identification information and the total number of points corresponding to said customer identification information from a point management file, storing said customer identification information and the total number of points in a state associated with each other, a second predetermined period of time before the expiration of the term of point validity set equally with respect to all points;
an exchangeable-goods information readout step of reading out exchangeable goods information on the basis of the total number of points from an exchangeable-goods information file storing the number of points and said exchangeable goods information in a state associated with each other;
a message edit step of editing an message including the total number of points and said exchangeable goods information; and
a message transmission step of transmitting said message through a network to a customer terminal on the basis of said customer identification information.

29. A computer-readable recording medium in which a point notification program, for notifying information on points to customers who have a right to utilize a point service, is stored, wherein said point notification program instructs the computer to execute the following steps of:
a customer identification information readout step of reading out customer identification information on a customer, who has points a second predetermined period of time before the expiration of the term of point validity, on the basis of purchase date information from a purchase history file storing said customer identification information and said purchase date information in a state associated with each other;
a total point readout step of reading out the total number of points on the basis of said customer identification information from a point management file storing said customer identification information and the total number of points in a state associated with each other;
an exchangeable-goods information readout step of reading out exchangeable goods information on the basis of the total number of points from an exchangeable-goods information file storing the number of points and said exchangeable goods information in a state associated with each other;
a message edit step of editing an message including the total number of points and said exchangeable goods information; and
a message transmission step of transmitting said message through a network to a customer terminal on the basis of said customer identification information.

30. A computer-readable recording medium according to claim 29, wherein, in said customer identification information readout step, said point notification program makes said computer read out customer identification information on a customer who has points said second predetermined period of time before the expiration of the term of point validity, on the basis of information on the date of the first utilization stored in said purchase history file.

31. A computer-readable recording medium according to claim 28, wherein, in said exchangeable-goods information readout step, said point notification program makes said computer read out information on goods exchangeable for the total number of points.

32. A computer-readable recording medium according to claim 23, wherein said point notification program makes said computer execute the processing further including a category readout step of reading out a category of purchased goods by each customer from a purchase history file storing said customer identification information and said category in a state associated with each other, on the basis of said customer identification information read out in one of said customer identification information readout step and said customer identification information/total point readout step, in said exchangeable-goods information readout step, said point notification program makes said computer read out said exchangeable goods information on the basis of said category and the total number of points from said exchangeable-goods information file storing the number of points, said category and said exchangeable goods information in a state associated with each other.

33. A computer-readable recording medium according to claim 23, wherein said point notification program makes said computer edit said message including link information linked to a home page putting information on a point service.

34. A point notification system used for notifying information on points to customers who have a right to utilize a point service, comprising:
customer identification information readout means for reading out customer identification information on a customer, who has not purchased goods for a first predetermined period of time, on the basis of purchase date information from a purchase history file storing said customer identification information and said purchase date information in a state associated with each other;
total point readout means for reading out the total number of points on the basis of said customer identification information from a point management file storing said customer identification information and the total number of points in a state associated with each other;
exchangeable-goods information readout means for reading out exchangeable goods information on the basis of the total number of points from an exchangeable-goods information file storing the number of points and said exchangeable goods information in a state associated with each other;
message editing means for editing a message including the total number of points and said exchangeable goods information; and
outputting means for outputting said message with respect to each customer identification information.

35. A point notification system used for notifying information on points to customers who have a right to utilize a point service, comprising:
customer identification information/total point readout means for reading out customer identification information and the total number of points corresponding to said customer identification information from a point management file storing said customer identification information and the total number of points in a state associated with each other;
exchangeable-goods information readout means for reading out information on exchangeable goods for the number of points one grade higher than the total number of points from an exchangeable-goods information file storing the number of points and said exchangeable goods information in a state associated with each other;
message editing means for editing an message including the total number of points and said exchangeable goods information; and
outputting means for outputting said message with respect to each of said customer identification information.

36. A point notification system used for notifying information on points to customers who have a right to utilize a point service, comprising:
customer identification information/total point readout means for reading out customer identification information and the total number of points corresponding to said customer identification information from a point management file, storing said customer identification information and the total number of points in a state associated with each other, a second predetermined period of time before the expiration of the term of point validity set equally with respect to all points;
exchangeable-goods information readout means for reading out exchangeable goods information on the basis of the total number of points from an exchangeable-goods information file storing the number of points and said exchangeable-goods information in a state associated with each other;
message editing means for editing an message including the total number of points and said exchangeable goods information; and
outputting means for outputting said message with respect to each of said customer identification information.

37. A point notification system used for notifying information on points to customers who have a right to utilize a point service, comprising:
customer identification information readout means for reading out customer identification information on a customer, who has points a second predetermined period of time before the expiration of the term of point validity, on the basis of purchase date information from a purchase history file storing said customer identification information and said purchase date information in a state associated with each other;
total point readout means for reading out the total number of points on the basis of said customer identification information from a point management file storing said customer identification information and the total number of points in a state associated with each other;
exchangeable-goods information readout means for reading out exchangeable goods information on the basis of the total number of points from an exchangeable-goods information file storing the number of points and said exchangeable goods information in a state associated with each other;
message editing means for editing an message including the total number of points and said exchangeable goods information; and
outputting means for outputting said message with respect to each of said customer identification information.
